(19) United States
(12) Patent Application Publication
(10) Pub. No.: US 2010/0064642 A1
(43) Pub. Date: Mar. 18, 2010

(54) AUXILIARY HORSE SADDLE FOR CHILDREN

(76) Inventor: Jimmy D. Talent, Albuquerque, NM (US)

Correspondence Address: The Adams Law Firm, Suite H262, 901 Rio Grande Blvd. NW, Albuquerque, NM, 87104, US

(21) Appl. No.: 12/558,357

(22) Filed: Sep. 11, 2009

Related U.S. Application Data
(60) Provisional application No. 61/096,210, filed on Sep. 11, 2008.

(51) Int. Cl. B68C 1/04; B68C 1/02

(52) U.S. Cl. 54/44.2

(57) ABSTRACT

An auxiliary saddle for use with an adult saddle for accommodating a small rider, such as a child, on a horse.

### CROSS REFERENCE TO RELATED APPLICATION

This application fully incorporates by reference the contents of U.S. Provisional Application No. 61/096,210 entitled “Horse Tack for Children” filed Sep. 11, 2008.

### FIELD OF THE INVENTION

This invention relates to horse tack.

### BACKGROUND

It is generally understood that when a child learns to ride a horse, one of the problems is that the typical adult saddle has a seat that is generally too large. A typical adult saddle seat is much larger than necessary for the seat of a child. As a result, the child's seat moves excessively with respect to the saddle seat causing irritation and discomfort as well as interfering with the child's proper riding habits and control of the horse for safety as well as performance. An adult saddle is also unsuitable for a child in that the stirrups on an adult saddle are typically not adjustable to the right length from the saddle seat to the stirrup to accommodate the shorter legs of a child.

The alternative for a child rider is to purchase a saddle especially made for children, that is, having both seat and stirrup sizes suitable for a child. The problem with youth saddles is that they typically cost $500-$1000 in the current marketplace and may only be used for three or four years before the saddle seat is too small or the child has matured into an adult. A typical youth saddle seat will have a longitudinal dimension (that is, the direction of the horse's spine) of 12″-13″.In the typical adult saddle, the seat measured along that same longitudinal axis will be between 15″ and 17″. Although the difference in dimensions is not large, it is very important for providing comfort for the rider and the horse. It is to be understood that while the terms “child” and “children” are used to describe the typical rider for whom the auxiliary saddle is intended, children vary substantially in size depending on age and other factors. The auxiliary saddle will be suitable for the average child 3 to 10; however, it may also be suitable for young and/or petite adults.

### SUMMARY OF THE INVENTION

One embodiment of the present horse tack invention comprises an auxiliary saddle for use with a standard adult saddle having the usual components: a seat, a horn, a cantle, D-rings, a cinch and straps for securing the saddle to the horse in a variety of ways all of which are well known in the art. The auxiliary saddle comprises a seat that is shorter in the longitudinal direction than the adult saddle seat, at least one strap attached to the front end of the auxiliary seat for attachment to the adult saddle horn, at least one strap attached to the front end of the auxiliary saddle for attachment to the forward D-rings on each side of the adult saddle, at least one strap attached to the rear lower end of the auxiliary saddle for attachment to the rearward D-rings on each side of the adult saddle, at least one strap secured to the auxiliary seat and depending downward on each side of the horse, and a pair of stirrups connected to the strap whereby the auxiliary saddle may be secured to the adult saddle through the straps to inhibit forward, rearward or transverse movement of the auxiliary saddle relative to the adult saddle. This allows the auxiliary saddle and stirrups to be positioned properly for a child and secured with no movement at all. This provides a safer seat for the child.

### BRIEF DESCRIPTION OF THE DRAWINGS

FIG. 1 is a side view of a first embodiment of an auxiliary saddle constructed in accordance with the present invention;

FIG. 2 is a side view of the auxiliary saddle shown in FIG. 1 mounted on a standard adult saddle; and

FIG. 3 is a top plan view of a modified or second embodiment of an auxiliary saddle.

### DESCRIPTION OF THE EMBODIMENTS

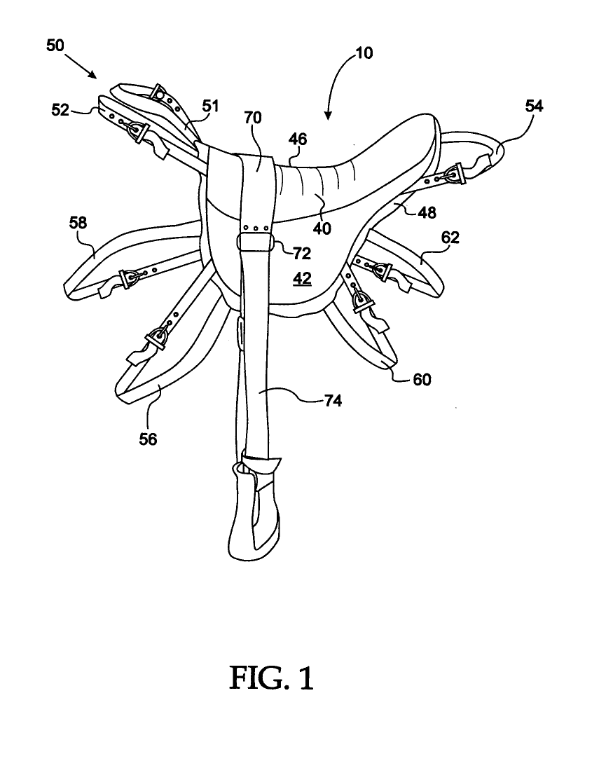

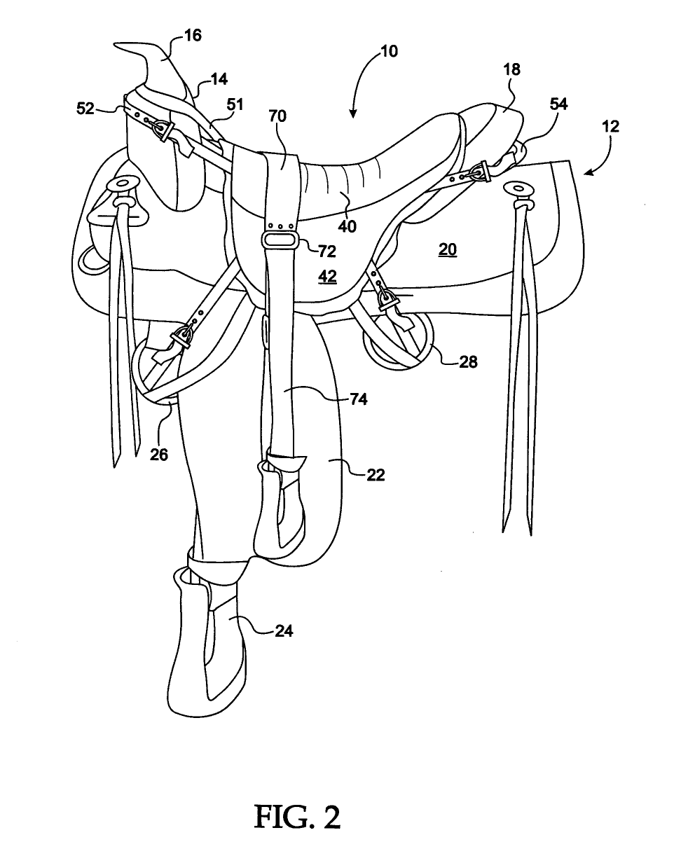

The child auxiliary saddle 10 is shown in FIG. 1. In FIG. 2 the saddle 10 is shown mounted on a standard adult saddle 12. The adult saddle 12 is shown as a western style saddle, but it will be readily understood that the invention may be used in conjunction with any style of saddle sized for adults. The adult saddle 12 is of standard construction and includes a tree frame or tree comprising two longitudinal bars (now shown), a swell 14 transversely attached to the two bars and having a horn 16 attached at the top of the swell and a cantle 18 which extends transversely across the bars at the rear or aft end of the saddle 12. The adult saddle also includes left and right hand skirts, such as the left-hand skirt 20 shown in FIG. 2. The adult saddle includes a seat section which as described above may have a longitudinal dimension of 15″-17″; the seat is not shown as it is covered by the auxiliary saddle 10. The adult saddle 12 is secured to the horse by means of girth rigging, such as a cinch and latigo straps, in the manner commonly known to those skilled in the art. The adult saddle 12 has stirrup assemblies each including a fender 22, a stirrup strap (not shown) to which is attached the stirrup 24. Attached to the saddle tree are fore and aft D-rings 26, 28 on each side of the horse.

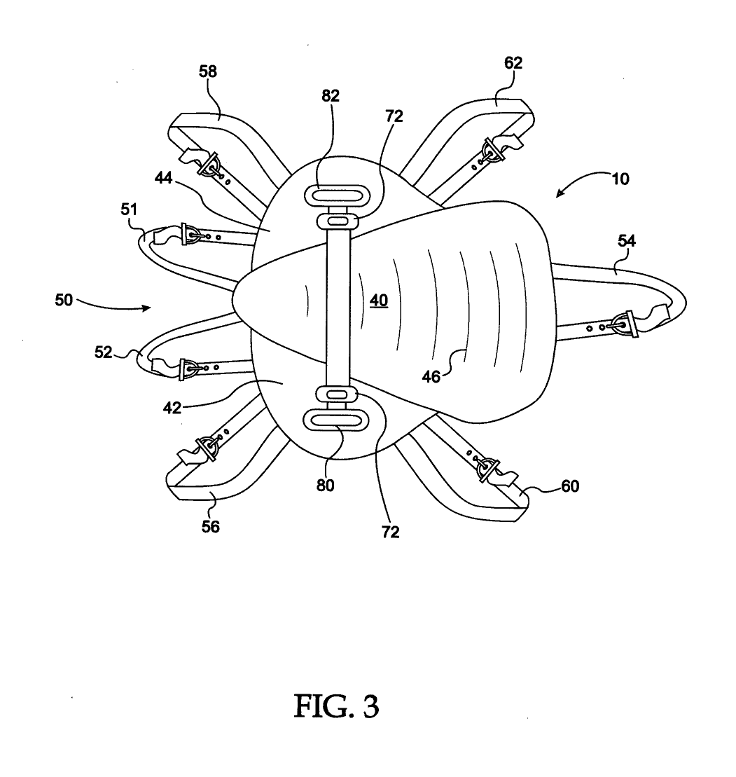

Returning now to FIG. 1, the embodiment of the auxiliary saddle 10 of the present invention is shown and comprises a seat portion 40, traditionally but not necessarily made of leather, to which are attached two side skirts, one shown in FIG. 1 at 42 and the other shown in FIG. 3 at 44. The seat may be padded as shown at 46. Beneath the auxiliary seat and skirt is a pad 48 made of flexible material. The pad generally conforms to the size of the area of the auxiliary seat 40 and accompanying side skirts 42, 44. The pad 48 may be slightly larger so as to extend beyond the peripheral edge of the seat and side skirts as shown in FIG. 1 or may be the same size and shape as the seat 40 and skirts 42, 44 as shown in FIG. 3. The pad 48 is made from a material that has a high frictional contact with the leather of the adult seat and the bottom surface of the auxiliary seat when the pad is positioned on the seat section of the adult saddle and beneath the seat section of the auxiliary saddle. A rubber or rubber-like material, or felt or soft leather material, may be used for pad 48. The purpose of the pad is to assist in preventing movement of the auxiliary saddle 10 with respect to the adult saddle 12 when the saddles are in use. In the embodiment of FIG. 3, the pad 48 is permanently attached to the bottom surface of the auxiliary saddle 10.

Means is provided for securely fastening or securing the auxiliary saddle 10 to the adult saddle 12. Such means may include a plurality of straps secured to the auxiliary saddle 10 for attachment to the adult saddle 12 as will be explained. At least one strap 50 is permanently attached to the front end of the auxiliary saddle for the purpose of attaching or securing the forward portion of the auxiliary saddle seat to the horn to thereby prevent rearward movement of the auxiliary saddle relative to the adult saddle. The at least one strap 50 in the first embodiment of FIG. 1 may comprise two separate straps 51, 52 each having a buckle for adjusting and cinching the front end of auxiliary saddle 10 to the horn 16. In the embodiment of FIG. 3, the strap 50 is attached to a pair of buckles connected directly to the front portion of the auxiliary saddle.

In the embodiment shown in FIG. 1, there is a strap 54 which may be secured around the cantle 18 on the adult saddle as shown in FIG. 2. In the embodiment shown in FIG. 3, there is no strap attached to the rear portion of the auxiliary saddle.

Attached to the lower front section of the skirt of the auxiliary saddle, on each side of the horse, are straps 56, 58 that, as seen best in FIG. 2, are attached to the adult saddle D-rings, such as D-ring 26. The purpose of straps 56, 58 attached to the adult saddle D-rings is to prevent the auxiliary saddle from moving up, that is, away from the adult saddle 12 and to prevent the auxiliary saddle 10 from moving rearwardly. A similar pair of straps 60, 62 are attached at the aft or flank end of the side skirts 42 of the auxiliary saddle 10, one on each side of the horse, and attached to the rearward D-rings of the adult saddle 12, so as to prevent upward or forward movement of the auxiliary saddle 10 relative to the adult saddle 12.

Each of the straps 50-62 may be made of leather or other strong, flexible material, and each is adjustable so as to permit tight cinching of the strap to the D-rings or horn or cantle. The adjustability may be provided through a common buckle although it will be readily understood that other types of adjustment devices may be used to securely mount the auxiliary saddle 10 to the adult saddle to prevent movement during use.

The auxiliary saddle 10 also includes stirrups. In the embodiment shown, a strap 70 is secured to the auxiliary seat 40 and extends transversely beyond the edges of the seat 40. The strap 70 may have, as shown in FIGS. 1 and 3, a D-ring 72 at each end through which stirrup straps 74, 76 pass on each side of the horse. The stirrup straps 74, 76 are attached to stirrups 80, 82 that are sized appropriately for the child rider and are adjustable to accommodate riders with different preferences for the position of the stirrups or related to the size of the rider.

From the above description it will be seen that the child saddle 10 is held securely in position through the series of straps 50-62 thus providing the necessary safety and comfort for the horse and rider. It will be readily appreciated that when the young rider reaches an adult size, the auxiliary saddle may be removed and the underlying adult saddle will be used by the rider.

Having described several embodiments in the invention, modifications will be evident to those skilled in the art without departing from the spirit of the invention as defined in the appended claims.

What is claimed:

1. An auxiliary saddle for use with a standard adult saddle for a horse, the adult saddle including a seat, a horn, a cantle, D-rings, a cinch, and straps for securing the adult saddle to a horse, said auxiliary saddle comprising:
an auxiliary seat that is shorter in the longitudinal direction than the standard horse adult saddle seat;
a sheet of flexible material providing frictional contact with the bottom surface of the auxiliary saddle and the top surface of the adult saddle seat, when the auxiliary seat is positioned on the adult saddle seat;
at least one strap fixedly attached to the front end of the auxiliary seat for attachment to the adult saddle horn;
at least two straps fixedly attached to the front lower portion of the auxiliary saddle, one on each side of the saddle, for attachment to the forward D-rings on each side of the adult saddle;
at least two straps fixedly attached to the rear lower portion of the auxiliary saddle, one on each side of the saddle, for attachment to the rearward D-rings on each side of the adult saddle;
a strap transversely secured to the auxiliary seat, each end of the strap provided with a D-ring, a pair of stirrups connected to the D-rings on opposite sides of the horse;
whereby the auxiliary saddle can be secured to the adult saddle through the straps and aided by the frictional contact of the sheet with the adult and auxiliary saddles to inhibit forward, rearward or transverse movement of the auxiliary saddle relative to the adult saddle.

2. The auxiliary saddle of claim 1 wherein at least some of the straps are leather.

3. The auxiliary saddle of claim 1 wherein all of the straps are adjustable.

4. The auxiliary saddle of claim 1 wherein each of the straps comprise two separate strap segments joined by a buckle.

5. The auxiliary saddle of claim 1 wherein the auxiliary saddle comprises an integral seat section and pair of side skirts.

6. The auxiliary saddle of claim 1 wherein each stirrup is attached at one end to a strap, the other end fixedly attached to the auxiliary saddle seat, each said stirrup strap being adjustable.

7. The auxiliary saddle of claim 1 wherein the sheet is permanently attached to the bottom surface of the auxiliary saddle.

8. The auxiliary saddle of claim 1 wherein the flexible sheet is rubber-like.

9. The auxiliary saddle of claim 1 wherein the flexible sheet is rubber.

10. The auxiliary saddle of claim 5 wherein the auxiliary seat is leather.

11. The auxiliary saddle of claim 10 wherein the auxiliary seat is padded.

12. An auxiliary saddle for use with an adult saddle for a horse, the adult saddle including a seat, a horn, D-rings, a cinch, and straps for securing the adult saddle to a horse, said auxiliary saddle comprising:
an auxiliary seat that is generally smaller than the adult saddle seat;
at least one strap attached to the auxiliary seat for attachment to the adult saddle horn;
at least one strap attached to the front lower end of the auxiliary saddle for attachment to the forward D-rings on each side of the adult saddle;
at least one strap attached to the rear lower end of the auxiliary saddle for attachment to the rearward D-rings on each side of the adult saddle;
a pair of stirrups attached to the auxiliary saddle on opposite sides of the horse;
whereby the auxiliary saddle can be secured to the adult saddle through the straps to inhibit forward, rearward or transverse movement of the auxiliary saddle relative to the adult saddle.

13. A child auxiliary leather saddle for use with a standard adult leather saddle for a horse, the adult saddle including a seat, a tree frame, a horn, forward and rearward D-rings, a cinch, stirrups, and straps for securing the saddle to a horse, said auxiliary saddle comprising:
an auxiliary leather seat that is shorter in the longitudinal direction than the adult saddle seat; side skirt on each side of the horse attached to the auxiliary seat;
a rubber-like material sheet of approximately the same size as the leather auxiliary seat and side skirts positioned on the adult saddle seat, the auxiliary seat and side skirts positioned on the rubber-like sheet;
at least two leather straps fixedly attached to the front end of the auxiliary seat for attachment to the adult saddle horn;
at least two leather straps fixedly attached to the front lower end of the auxiliary saddle side skirts, one on each side of the saddle, for attachment to the forward D-rings on each side of the adult saddle;
at least two leather straps fixedly attached to the rear lower end of the auxiliary saddle side skirts, one on each side of the saddle, for attachment to the rearward D-rings on each side of the adult saddle;
at least one leather strap transversely arranged and secured to the auxiliary seat, each end of the at least one strap provided with a D-ring, a pair of adjustable stirrup straps attached to the D-rings on opposite sides of the horse;
A pair of stirrups attached to the stirrup straps;
whereby the auxiliary saddle can be secured to the adult saddle through the straps to prevent forward, rearward or transverse movement of the auxiliary saddle relative to the adult saddle.

14. The auxiliary saddle of claim 12 wherein the auxiliary seat is padded.

15. The auxiliary saddle of claim 13 wherein the rubber-like material sheet is permanently attached to the lower surface of the auxiliary saddle.

16. The auxiliary saddle of claim 12 wherein the forward straps are attached to the front lower portion of the side skirts and the rearward straps are attached to the rear lower portion of the side skirts.
